(19) United States
(12) Patent Application Publication
(10) Pub. No.: US 2024/0217442 A1
(43) Pub. Date: Jul. 4, 2024

(54) LUGGAGE LOADING DEVICE FOR VEHICLES

(71) Applicants: HYUNDAI MOTOR COMPANY, Seoul (KR); KIA CORPORATION, Seoul (KR); SEOYON E-HWA CO., LTD., Anyang-si (KR)

(72) Inventors: Ji Ah Kim, Seoul (KR); Ji Seob Park, Incheon (KR); Jin Ho Hwang, Cheonan-si (KR); Hyung Won Jin, Gwangmyeong-si (KR)

(73) Assignees: HYUNDAI MOTOR COMPANY, Seoul (KR); KIA CORPORATION, Seoul (KR); SEOYON E-HWA CO., LTD., Anyang-si (KR)

(21) Appl. No.: 18/371,109

(22) Filed: Sep. 21, 2023

(30) Foreign Application Priority Data
Jan. 2, 2023 (KR) 10-2023-0000027

(51) Int. Cl. B60R 5/00

(52) U.S. Cl. CPC B60R 5/003

(57) ABSTRACT

A luggage loading device for vehicles includes a main body unit configured such that a loading area is capable of being divided into a plurality of sub-loading areas configured to load luggage therein, and the main body unit is configured to selectively slide along a movement path in a vehicle. The loading area is formed by guide frames provided in forward and rearward directions and side walls provided in leftward and rightward directions.

### CROSS-REFERENCE TO RELATED APPLICATION

This application claims under 35 U.S.C. § 119(a) the benefit of priority to Korean Patent Application No. 10-2023-0000027 filed on Jan. 2, 2023, the entire contents of which are incorporated herein by reference.

### BACKGROUND

### (a) Technical Field

The present disclosure relates to a luggage loading device for vehicles. More particularly, it relates to an interior luggage loading device for vehicles that fixes luggage to the interior of a vehicle having both a boarding space for passengers and a storage space for luggage.

### (b) Background Art

In general, a vehicle trunk is a dedicated space separated from the interior of a vehicle and designed to carry and store various pieces of luggage. The vehicle trunk is an indispensable feature provided in almost all types of vehicles and plays a key role in that the size of the trunk influences the marketability of the vehicle.

Therefore, vehicle manufacturers are putting in a lot of effort to maximize the size of the interior space of the trunk of a vehicle within an allowable range in consideration of the design, dwelling ability, fuel efficiency, performance, and the like, of the vehicle during the vehicle design process.

Further, in order to maximize the availability of the trunk, a storage box configured to effectively store various articles may be provided in the trunk. The inner wall of the trunk may be generally finished with a nonwoven fabric so that various pieces of luggage loaded in the trunk may be fixed during driving.

Nevertheless, when a vehicle is driven in a state in which articles are loaded in the trunk, the loaded articles may freely move around causing the loaded articles to collide with one another and with the inner wall of the trunk. As a result, the loaded articles may break or become damaged.

Therefore, purpose built vehicles (PBVs) that have both a boarding space for passengers and a dedicated storage space for luggage have emerged on the market. With the availability of PBVs, there is a convenient option to store luggage in a passenger seat rather than in the trunk of a vehicle so as to improve accessibility to the loaded luggage and to provide convenience in loading and unloading the luggage.

However, when storing the luggage in the passenger seat, it is essential to ensure that the luggage does not invade the boarding space for passengers. Additionally, when the luggage stored in the passenger seat is not properly secured, there is a risk that the luggage may collide with a passenger, potentially causing direct injury to the passenger.

The above information disclosed in this Background section is only to enhance understanding of the background of the disclosure. Therefore, the Background section may contain information that does not form the prior art that is already known to a person of ordinary skill in the art.

### SUMMARY

Therefore, in view of the forgoing, a structure is required to effectively load a substantial amount of luggage while securely fastening the luggage in place.

The present disclosure has been made in an effort to solve the above-described problems associated with the prior art. An object of the present disclosure is to provide a luggage loading device for vehicles. The luggage loading device includes a plate withdrawn from a driver's seat partition at a designated height in a vehicle having both a boarding space for passengers and a storage space for luggage. The luggage loading device includes a multistage structure having a first loading layer and a second loading layer due to selective withdrawal of the plate, is provided with a plurality of partitions on the first loading layer so as to divide a loading area and may thus guide the luggage so as to be effectively loaded in the loading area. Further, the luggage loading device is configured such that one side of the loading area may be opened and the height of the side surface of the first loading layer may be selectively lowered. Thus, the luggage may be easily loaded in the luggage loading device.

In one aspect, the present disclosure provides a luggage loading device for vehicles including a main body unit with a loading area capable of being divided into a plurality of sub-loading areas configured to load luggage therein. The main body unit is further configured to selectively slide along a movement path in a vehicle. The loading area is formed by guide frames provided in forward and rearward directions and side walls provided in leftward and rightward directions.

In an embodiment, the luggage loading device may further include an auxiliary body unit configured to be positioned in a withdrawn state in a direction of covering the loading area. The auxiliary body unit is further configured to form an auxiliary loading area having a multistage structure with the loading area so that luggage may be loaded in the auxiliary loading area in the withdrawn state of the auxiliary body unit.

In another embodiment, the main body unit may include a main body configured such that the loading area is formed therein. The main body unit may also include guide rails mounted on a lower part of the main body and coupled to sliding rails fixed to a vehicle body so as to allow the main body to slide.

In still another embodiment, each of the guide rails may include a sliding guide mounted therein so as to come into direct contact with a corresponding one of the sliding rails. The sliding guide may be formed of mono-cast (MC) nylon.

In yet another embodiment, the main body unit may further include a front latch configured to engage a striker that protrudes on the movement path so as to fix a position of the main body as the main body slides from an initial position thereof to a withdrawn position. The main body unit may further include a rear latch disposed to be spaced apart from the front latch and may be configured to engage the striker so as to fix the position of the main body as the main body slides from the withdrawn position to the initial position.

In still yet another embodiment, the main body unit may further include a control panel coupled to the main body. The control panel may be configured to control the main body so as to selectively disengage the front latch or the rear latch from the striker.

In yet still another embodiment, the control panel may include a button member provided to be exposed, rotating links configured to be rotated as the button member is pressed, and operating wires. The operating wires may be configured to be connected to the rotating links and to extend towards the front latch and the rear latch. Furthermore, the operating wires may be configured to be pulled due to rotation of the rotating links so as to disengage the front latch and the rear latch from the striker.

In a further embodiment, the main body unit may further include partition members configured to divide the loading area into the plurality of sub-loading areas.

In another further embodiment, one side of each of the partition members may be inserted into a corresponding one of insert grooves provided in a second side wall among the side walls. Additionally, a remaining side of each of the partition members may be inserted into a corresponding one of receipt grooves provided on a first side wall among the side walls configured to face the second side wall. Thus, the partition members may be mounted in the loading area via the insert and receiving grooves.

In still another further embodiment, the insert grooves may be formed in a T shape corresponding to a shape of one side of each of the partition members and may be provided in the second side wall so as to be spaced apart from each other at equal intervals. The receipt grooves may be formed by a pair of protruding pieces configured to receive the remaining side of each of the partition members and may be provided on the first side wall so as to be spaced apart from each other at intervals equal to the intervals between the insert grooves.

In yet another further embodiment, each of the partition members may have a protrusion configured to be inserted into a corresponding one of guide slots provided in a bottom surface of the main body so as to be mounted in the loading area. The guide slots may be aligned with the insert grooves and the receipt grooves.

In still yet another further embodiment, the partition members may be provided so that heights thereof are adjustable. Additionally, the partition members may be provided at the same height or at different heights.

In a still further embodiment, the partition members may be provided to be slidable along the side walls so as to divide the loading area into the plurality of sub-loading areas having the same size or different sizes.

In a yet still further embodiment, each of the partition members may have a stopper engaged with a guide member configured to extend in a length direction of the side walls so as to be selectively slidable depending on disengagement of the stopper from the guide member.

In a still yet further embodiment, the main body unit may be configured such that the side walls include a first side wall and a second side wall. The first side wall may be disposed towards an entrance in the vehicle and may be partially openable.

In another further embodiment, the first side wall may include a handle formed to be gripped by a user's hand and a first gear engaged with a guide gear formed on the handle so as to be rotatable together with the guide gear as the handle is moved in an operating direction. The first side wall may further include second gears engaged with upper and lower parts of the first gear and disposed to overlap each other so as to be fixed to the guide frame and a fixed region of the first side wall. The second gears may be configured such that fixation of the second gears to the guide frame and the fixed region of the first side wall is released due to rotation of the first gear.

In another aspect, the present disclosure provides a luggage loading device for vehicles. The luggage loading device includes at least one main body unit with a loading area capable of being divided into a plurality of sub-loading areas configured to load luggage therein and configured to selectively slide along a movement path in a vehicle. The loading area is formed by guide frames provided in forward and rearward directions and side walls provided in leftward and rightward directions. The luggage loading device further includes at least one auxiliary body unit provided so as to be positioned in a withdrawn state in a direction of covering the loading area and configured to form an auxiliary loading area having a multistage structure with the loading area so that luggage maybe loaded in the auxiliary loading area in the withdrawn state of the at least one auxiliary body unit.

In an embodiment, the at least one main body unit may be configured such that at least one of the side walls provided in the leftward and rightward directions is selectively openable.

In another embodiment, the at least one main body unit may include a plurality of main body units configured such that movement directions thereof in the vehicle are the same or different.

In still another embodiment, the at least one auxiliary body unit may be mounted on at least one of a side wall of a partition of the vehicle. The partition may be configured to separate a driver's seat from other areas in the vehicle. The at least one auxiliary body unit may be mounted to a rear surface of a seat in the vehicle so as to form the auxiliary loading area.

Other aspects and embodiments of the disclosure are discussed below.

The above and other features of the disclosure are discussed below.

### BRIEF DESCRIPTION OF THE DRAWINGS

The above and other features of the present disclosure are described in detail with reference to certain embodiments thereof illustrated in the accompanying drawings which are given hereinbelow by way of illustration only, and thus are not limitative of the present disclosure, and wherein:

FIG. 1 is a schematic view of a luggage loading device for vehicles according to an embodiment of the present disclosure;

FIG. 2 is a perspective view of a main body unit of the luggage loading device according to an embodiment of the present disclosure;

FIG. 3 is a view showing an operation of a control panel of the luggage loading device according to an embodiment of the present disclosure;

FIG. 4 is a perspective view of a sliding guide of the luggage loading device according to an embodiment of the present disclosure;

FIG. 5 is a perspective view showing a sliding operation of the main body unit of the luggage loading device according to an embodiment of the present disclosure;

FIG. 6 is a view showing a sliding state of the main body unit of the luggage loading device according to an embodiment of the present disclosure;

FIG. 7 is a perspective view showing a loading area divided into a plurality of sub-loading areas in the luggage loading device according to an embodiment of the present disclosure;

FIGS. 8 and 9 are views showing mounting of a partition member in the luggage loading device according to an embodiment of the present disclosure;

FIG. 10 is a view showing a sliding structure of the partition member of the luggage loading device according to an embodiment of the present disclosure;

FIG. 11 is a view showing a structure for opening a side wall of the luggage loading device according to an embodiment of the present disclosure;

FIG. 12 is a view showing an operation of opening the side wall of the luggage loading device according to an embodiment of the present disclosure;

FIG. 13 is a perspective view showing an open state of the side wall of the luggage loading device according to an embodiment of the present disclosure; and

FIGS. 14a-14d are views showing moving directions of the main body unit of the luggage loading device according to an embodiment of the present disclosure.

It should be understood that the appended drawings are not necessarily drawn to scale, presenting a somewhat simplified representation of various features illustrative of the basic principles of the disclosure. The specific design features of the present disclosure as described herein, including, for example, specific dimensions, orientations, locations, and shapes, will be determined in part by the particular intended application and use environment.

In the figures, like reference numbers refer to the same or equivalent parts of the present disclosure throughout the several figures of the drawing.

### DETAILED DESCRIPTION

Hereinafter, reference is made in detail to various embodiments of the present disclosure, examples of which are illustrated in the accompanying drawings and described below.

Advantages and features of the present disclosure and methods for achieving the same should become apparent from the descriptions of aspects given herein below with reference to the accompanying drawings. When a component, device, element, or the like of the present disclosure is described as having a purpose or performing an operation, function, or the like, the component, device, element, or the like should be considered herein as being “configured to” meet that purpose or to perform that operation or function. Each of the component, device, element, and the like may separately embody or be included with a processor and a memory, such as a non-transitory computer readable media, as part of the apparatus.

However, the present disclosure is not limited to the aspects disclosed herein but may be implemented in various different forms. The aspects are provided to make the description of the present disclosure thorough and to fully convey the scope of the present disclosure to those having ordinary skill in the art. It is to be noted that the scope of the present disclosure is defined only by the claims.

Further, in the following description of the present disclosure, a detailed description of known functions and configurations incorporated herein has been omitted where it would have made the subject matter of the present disclosure rather unclear.

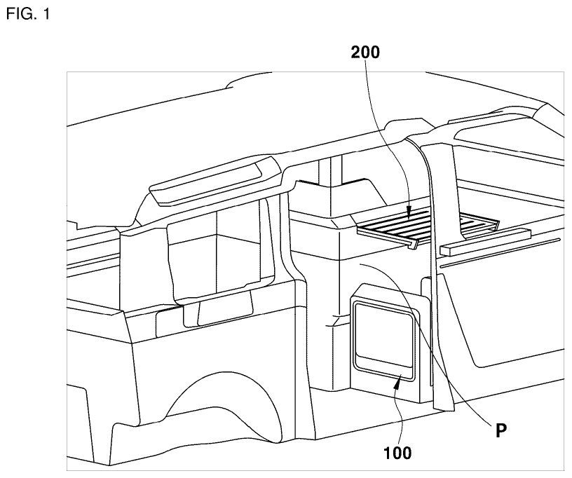

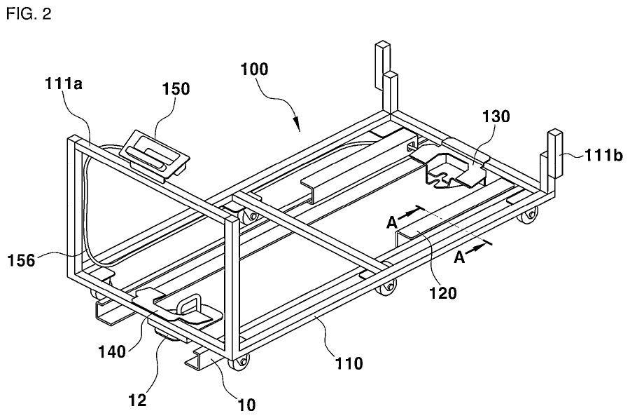

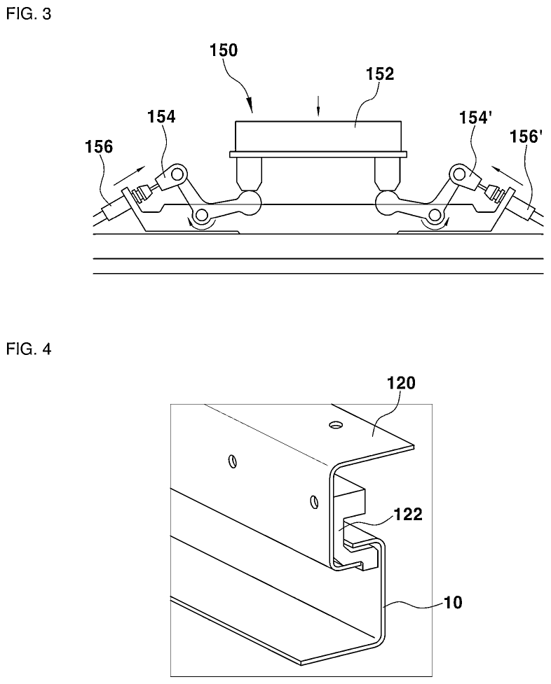

FIG. 1 is a schematic view of a luggage loading device for vehicles according to an embodiment of the present disclosure. FIG. 2 is a perspective view of a main body unit of the luggage loading device according to an embodiment of the present disclosure. FIG. 3 is a view showing operation of a control panel of the luggage loading device according to an embodiment of the present disclosure.

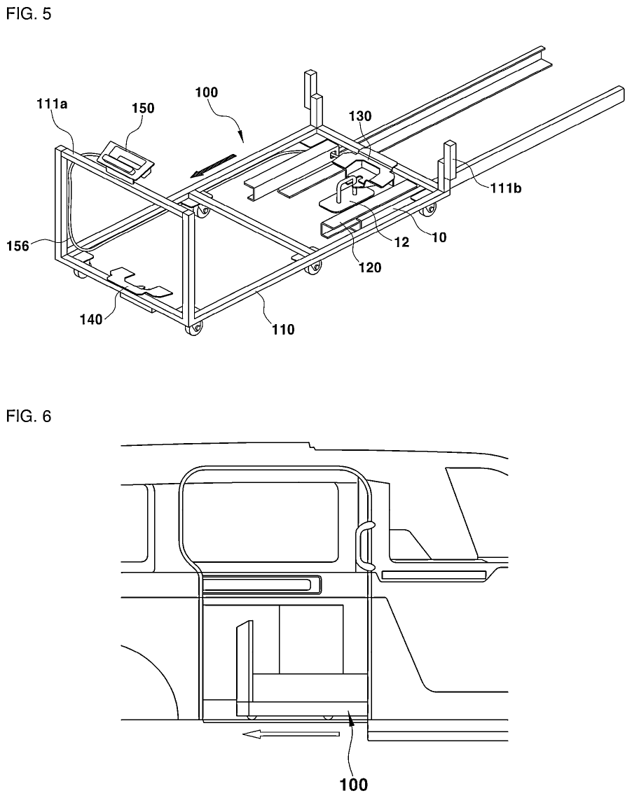

Further, FIG. 4 is a perspective view of a sliding guide of the luggage loading device according to an embodiment of the present disclosure. FIG. 5 is a perspective view showing a sliding operation of the main body unit of the luggage loading device according to an embodiment of the present disclosure. FIG. 6 is a view showing a sliding state of the main body unit of the luggage loading device according to an embodiment of the present disclosure.

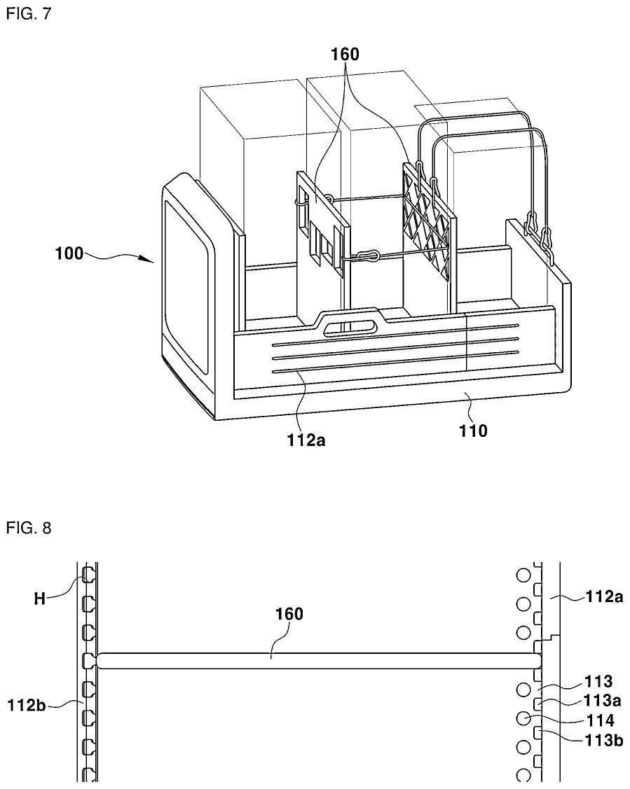

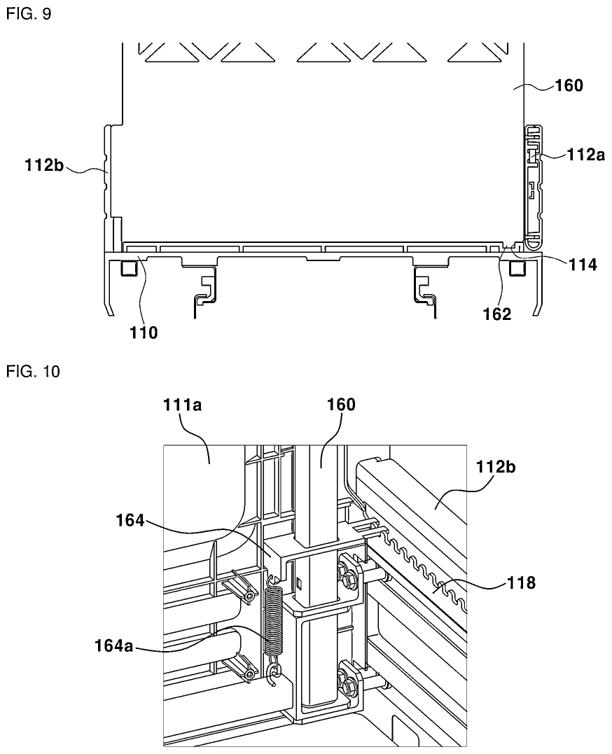

Moreover, FIG. 7 is a perspective view showing a loading area divided into a plurality of sub-loading areas in the luggage loading device according to an embodiment of the present disclosure. FIGS. 8 and 9 are views showing mounting of a partition member in the luggage loading device according to an embodiment of the present disclosure. FIG. 10 is a view showing the sliding structure of the partition member of the luggage loading device according to an embodiment of the present disclosure.

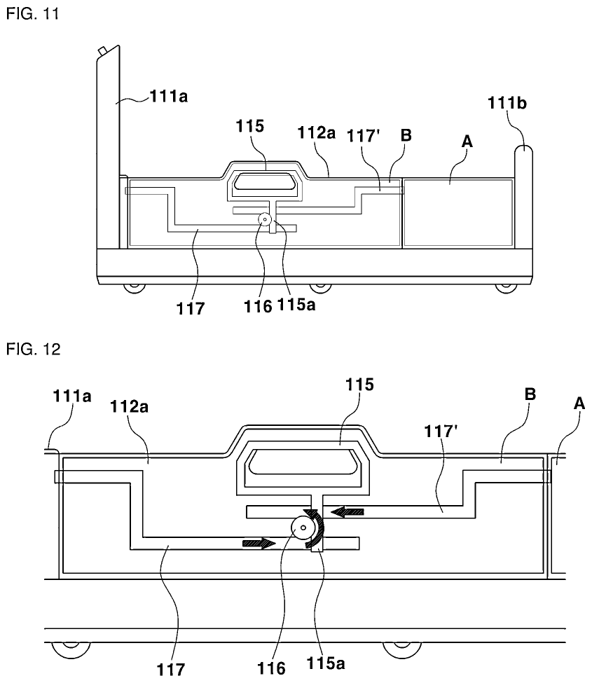

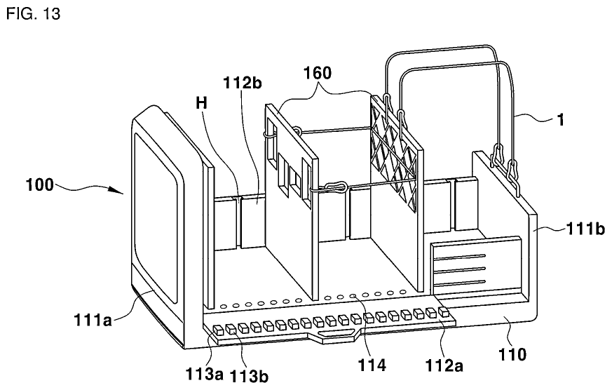

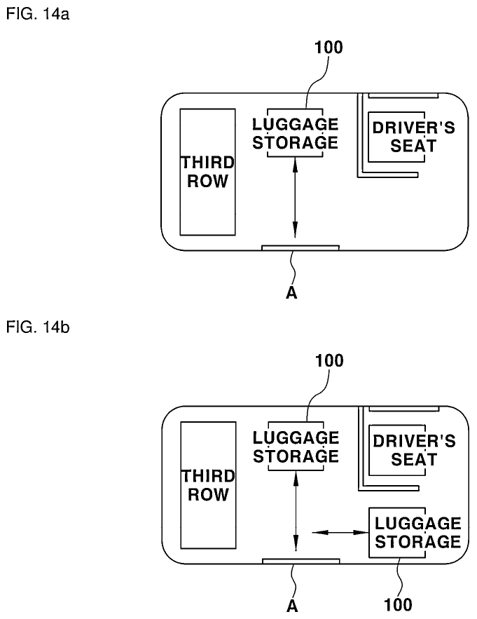

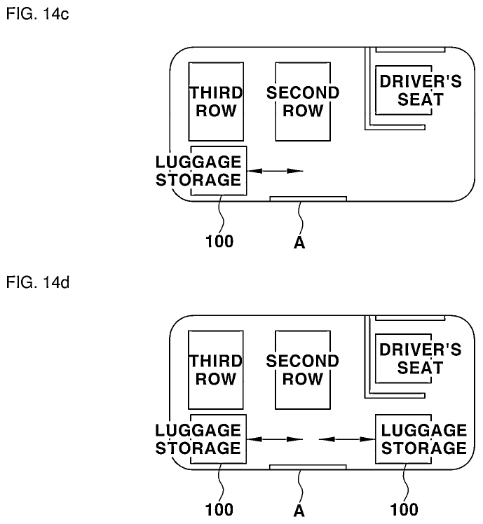

In addition, FIG. 11 is a view showing a structure for opening a side wall of the luggage loading device according to an embodiment of the present disclosure. FIG. 12 is a view showing an operation of opening the side wall of the luggage loading device according to an embodiment of the present disclosure. FIG. 13 is a perspective view showing the open state of the side wall of the luggage loading device according to an embodiment of the present disclosure. FIGS. 14a-14d are views showing the moving directions of the main body unit of the luggage loading device according to an embodiment of the present disclosure.

As shown in FIG. 1, a luggage loading device for vehicles according to an embodiment of the present disclosure includes a main body unit 100 and an auxiliary body unit 200.

The main body unit 100 is provided in the interior of a vehicle on a side wall of a partition P configured to divide or separate a driver's seat from other areas in the vehicle. The main body unit has a loading area divided into a plurality of sub-loading areas so that luggage is loaded in the sub-loading areas provided in the interior of the vehicle.

The loading area may be divided into the sub-loading areas, for example, three sub-loading areas, so that 24 inch carriers may be generally loaded therein (with reference to FIG. 7).

Further, the position of the main body unit 100 provided on the side wall of the partition P corresponds to only one embodiment and is not limited thereto. For example, in other embodiments, the main body unit 100 may be provided behind the partition P or between the second row seats and the third row seats in the vehicle, as needed. Accordingly, the auxiliary body unit 200 may also be provided at the corresponding position of the main body unit 100.

At least one main body unit 100 may be provided. The at least one main body unit 100 may be configured to be moved towards an entrance A in the same direction or in different directions in the vehicle, as shown in FIGS. 14a-14d.

The auxiliary body unit 200 serves to form an additional loading area other than the loading area formed by the main body unit 100. The auxiliary body unit 200 is provided at a designated height of the partition P so as to be withdrawn from a stowed state to a withdrawn state in a direction covering the loading area.

The auxiliary body unit 200 may be mounted on a side wall of the partition P of the vehicle. The partition P is configured to divide or separate the driver's seat from other areas of the vehicle. Alternatively, the auxiliary body unit 200 may be mounted on a rear surface of a seat in the vehicle so as to form a multistage structure with the loading area of the main body unit 100 (with reference to FIGS. 14a-14d). The auxiliary body unit 200 may thus form an auxiliary loading area having the multistage structure with the loading area of the main body unit 100, thereby allowing more luggage to be loaded in the vehicle.

Further, the main body unit 100 includes a main body 110 and guide rails 120, as shown in FIG. 2. The main body unit 100 is configured to selectively slide along a movement path formed by sliding rails 10 in the vehicle (with reference to FIG. 6).

The loading area is formed in the main body 110 by coupling guide frames 111a and 111b provided in forward and rearward directions and side walls 112a and 112b provided in leftward and rightward directions along the edge of the bottom surface of the main body 110. The main body 110 is provided to have a designated size so as not to interfere with seats in the vehicle.

The guide rails 120 are mounted on the lower part of the main body 110. The guide rails 120 are coupled to the sliding rails 10 fixed to a vehicle body so as to allow the main body 110 to slide.

The guide rails 120 are formed to have a C-shaped cross-section corresponding to the cross-sectional shape of the sliding rails 10. More particularly, a sliding guide 122 may be mounted in each of the guide rails 120 so that the main body 110 may effectively slide along the sliding rails 10. This is shown in FIG. 4, which is a cross-sectional view taken along line A-A of FIG. 2.

For example, the sliding guide 122 may be formed of mono-cast (MC) nylon. As a result, when the sliding guides 122 of the guide rails 120 come into direct contact with the sliding rails 10, the main body 110 may slide quietly and smoothly due to the material characteristics of MC nylon.

The main body unit 100 may further include a front latch 130 and a rear latch 140 configured to achieve sliding and fixing of the main body 110 by operating a control panel 150.

For example, the front latch 130 is configured to engage a striker 12 protruding on the movement path. The striker 12 is between the sliding rails 10 and, as the main body 110 slides from an initial position thereof to a withdrawn position, the main body 110 is fixed at the withdrawn position.

Further, the rear latch 140 is disposed on the lower part of the main body 110 so as to be spaced apart from the front latch 130. The rear latch 140 is configured to engage the striker 12 (with reference to FIG. 2). As the main body 110 slides from the withdrawn position to the initial position, the main body 110 is fixed at the initial position.

The control panel 150 is coupled to the guide fame 111a of the main body 110. The control panel 150 guides (e.g., controls) the main body 110 so as to selectively disengage the front latch 130 or the rear latch 140 from the striker 12. Thus, the control panel 150 includes a button member 152, rotating links 154 and 154′, and operating cables, rods, or wires 156 and 156′, as shown in FIG. 3.

In other words, the button member 152 is provided to be exposed to the outside of the main body unit and can be pressed by a user. The rotating links 154 and 154′ are rotated about a pivot as the button member 152 is pressed and the operating wires 156 and 156′ are connected to the pair of the rotating links 154 and 154′. The operating wires 156 and 156′ extend towards the front latch 130 and the rear latch 140 and are pulled due to the rotation of the rotating links 154 and 154′ so as to disengage the front latch 130 or the rear latch 140 from the striker 12, depending on the fixed position of the main body unit.

Referring to FIGS. 2, 3, and 5, a process of fixing the main body 110 at the respective sliding positions through the above-described configuration of the main body unit 100 is sequentially described as follows.

As shown in FIG. 2, at the initial position of the main body 110, the rear latch 140 is located to be engaged with the striker 12. In order to be able to slide the main body 110 from the initial position (see FIG. 3) to the withdrawn position, the button member 152 is pressed first.

When the button member 152 is pressed, the rotating links 154 and 154′ are rotated, as shown in FIG. 3. In this case, the operating wires 156 and 156′ are pulled due to the L-shaped bend of the rotating links 154 and 154′ at the time of rotating the rotating links 154 and 154′.

Thereby, since the operating wire 156 connected to the rotating link 154 provided at one side is connected to the front latch 130, and the operating wire 156′ connected to the rotating link 154′ provided at the other side is connected to the rear latch 140, both the front latch 130 and the rear latch 140 are operated when the button member 152 is pressed. Therefore, the front latch 130 and the rear latch 140 are actuated, which disengages the latch from the striker 12 in FIG. 3 when the button member 152 is pressed.

In the state in which the rear latch 140 is disengaged from the striker 12, the main body 110 may slide from the initial position to the withdrawn position. Additionally, when the striker 12 is caught by the front latch 130 (see FIG. 5) with a click after the main body 110 slides to a designated working distance in the withdrawn position, the main body 110 at the sliding position thereof may be fixed. Thus, luggage may be easily loaded in the loading area at the fixed position of the main body 110. The button 152 may be pressed to disengage the front latch 130 to again slide the main body 110 from the withdrawn position to the initial position.

The main body unit 100 may further include partition members 160 configured to divide the loading area of the main body unit 100 into a plurality of sub-loading areas, in which luggage is loaded, as shown in FIG. 7.

One side of each of the partition members 160 is inserted into a corresponding one of insert grooves H provided in the second side wall 112b among the side walls 112a and 112b. The other side of each of the partition members 160 is inserted into a corresponding one of receipt grooves 113 provided on the first side wall 112a facing the second side wall 112b, as shown in FIG. 8. Thus, the partition members 160 are mounted in the loading area of the main body unit 100.

In other words, when the partition member 160 is lowered in the state in which one side and the other side of the partition member 160 coincide with the insert groove H and the receipt groove 113, the partition member 160 is mounted in a rail coupling manner. Thus, the loading area in the main body unit 100 may be easily divided by the installed partition member 160.

More particularly, the insert grooves H are formed in a T shape corresponding to the T-shape of one side of each of the partition members 160. Multiple insert grooves H are provided in the second side wall 112b so as to be spaced apart from each other at equal intervals. The receipt grooves 113 are formed by respective pairs of protruding pieces 113a and 113b that are spaced apart and configured to define the groove to receive the other side of each of the partition members 160. Multiple receipt grooves 113 are provided on the first side wall 112a so as to be spaced apart from each other at intervals equal to the intervals between and aligned with the insert grooves H. Thus, such a structure allows the partition members 160 to be firmly fixed in the loading area at selected positions.

The partition members 160 may have a protrusion 162 configured to be inserted into a corresponding one of holes or guide slots 114 provided in the bottom surface of the main body 110 when mounted in the loading area, as shown in FIG. 9.

Multiple guide slots 114 are formed in the bottom surface and aligned with corresponding ones of the insert grooves H and the receipt grooves 113 (with reference to FIG. 8). Thus, not only one side and the other side of a partition member 160 may be fixed but also the lower part of the partition member 160 may be fixed. Thus, the partition member 160 may be more effectively fixed or held in place when installed.

Further, the partition member 160 may be formed in a structure in which a plurality of holes having different shapes is formed in the upper end of the partition member 160 (with reference to FIG. 13). Separate straps 1 may be easily connected (coupled) to the partition member 160 through such a hole structure. Thus, the upper region of the loading area may be effectively shielded, and as a result may prevent or restrain luggage loaded in the loading area from being separated from the loading area.

In addition, one or more of the partition members 160 may also be provided so that the heights thereof are adjustable. Additionally, the partition members 160 may be provided at the same height or at different heights.

In order to implement these characteristics, although not shown in the drawings, the partition members 160 may be formed in a multistage or multi-part structure. In such an example, the upper part of each of the adjustable partition members 160 may be foldable with respect to the lower part of each of the partition members 160 so as to adjust the heights of the partition members 160.

The partition members 160 are not limited to the above-mentioned structure to adjust the heights of the partition members 160. Other structures to adjust the heights of the partition members 160 may be applied. Additionally, the structures to adjust the heights of the partition members 160 may be selectively applied in consideration of the layout of the luggage loading device or the like.

Further, the partition members 160 may be provided to be slidable along the side walls 112a and 112b so as to divide the loading area in the main body unit 100 into sub-loading areas having the same size or sub-loading areas having different sizes.

For this purpose, the partition member 160 may have a stopper 164, as shown in FIG. 10. The stopper 164 may be engaged with a guide member 118 configured to extend in the length direction of the side walls 112a and 112b, i.e., may be engaged with gear teeth of the guide member 118. The partition member 160 may be fixed by an elastic member 164a at the position where the stopper 164 is engaged with the gear teeth of the guide member 118.

In order to divide the loading area into sub-loading areas having the same size or sub-loading areas having different sizes, the partition member 160 is moved in a sliding manner in the state in which the partition member 160 is lifted by applying a greater force than the elastic restoring force of the elastic member 164a. When the partition member 160 is returned or lowered to the initial position thereof at the selected corresponding sliding position, the elastic restoring force of the elastic member 164a is again applied to the partition member 160. Division of the loading area may thus be easily adjusted in this embodiment.

The main body unit 100 may be configured such that, among the first side wall 112a and the second side wall 112b, for example, the first side wall 112a is disposed towards the entrance in the vehicle and is partially openable (with reference to FIG. 6).

For this purpose, the first side wall 112a includes a handle 115, a first gear 116, and second gears 117 and 117′, as shown in FIG. 11.

First, the handle 115 is formed to be gripped by a user's hand and is provided to be elevated and lowered in an operating direction.

The first gear 116 is engaged with a guide gear 115a that is formed on the handle 115 so as to be rotated together with the guide gear 115a as the handle 115 is moved in the operating direction.

The second gears 117 and 117′ are engaged with the upper and lower parts of the first gear 116. The second gears 117 and 117′ are disposed to overlap each other and extend in opposite directions with portions to be fixed to the guide frame 111a and a fixed region of the first side wall 112a. The fixed region of the first side wall 112a is divided into a first region A and a second region, i.e., the side surface of the first region A. Additionally, the second gears 117 and 117′ are configured such that fixation of the second gears 117 and 117′ to the guide frame 111a and the first region A is released due to rotation of the first gear 116 in a reverse direction.

That is to say, as shown in FIG. 12, when the handle 115 is elevated in the operating direction, the guide gear 115a is also elevated and rotates the first gear 116 in the reverse direction. As a result, the second gears 117 and 117′ are respectively moved inwards by rotation of the first gear 116, and fixation of the respective ends of the second gears 117 and 117′ to the guide frame 111a and the first region A is released.

Therefore, as shown in FIG. 13, the first side wall 112a may be partially opened, i.e., the second region B of the first side wall 112a may be opened. Thus, the height of the first side wall 112a of the main body 110 that is configured to load luggage therein may be lowered to a height whereby the luggage need not to be lifted very high or at all from the ground. As a result, the luggage may be easily loaded.

Although the first side wall 112a is described as being divided into the first region A and the second region B, with only the second region B being openable, it is important to note that this structure corresponds to just one embodiment. Alternatively, the first side wall 112a may be formed in a structure in which the entirety of the first side wall 112a is openable.

Further, while the first side wall 112a that is disposed towards the entrance in the vehicle may be selectively opened, the first side wall 112a and the second side wall 112b may have the same openable structure. As a result, both sides of the main body unit 100 may be opened in the state in which a passenger enters in the vehicle so that luggage may be easily loaded in the main body unit 100.

The luggage loading device according to the present disclosure includes a plate withdrawn from a driver's seat partition at a designated height in a vehicle having both a boarding space for passengers and a storage space for luggage. The luggage loading device includes a multistage structure having a first loading layer and a second loading layer due to selective withdrawal of the plate and is provided with a plurality of partitions on the first loading layer so as to divide a loading area. As a result, the luggage loading device is capable of guiding the luggage so as to be effectively loaded in the loading area.

Further, the luggage loading device according to the present disclosure is configured such that one side of the loading area may be opened. As a result, the height of the side surface of the first loading layer may be selectively lowered. Thus, a height to which the luggage needs to be lifted from the ground may be lowered, and thus, the luggage may be easily loaded in the luggage loading device.

Moreover, in the luggage loading device according to the present disclosure, the partition may be transformed into a structure configured to couple straps thereto so as to fix the luggage loaded in the loading area. As a result, the luggage loading device is capable of preventing the loaded luggage from being separated from the loading area and preventing passengers in the vehicle from being injured due to separation of the luggage from the loading area.

In addition, the luggage loading device according to the present disclosure has a multistage structure including the first loading layer and the second loading layer so that luggage is loaded on the second loading layer in the state in which loading of luggage on the first loading layer has been completed. As a result, the luggage loading device is capable of allowing more luggage to be loaded in the interior of the vehicle and stably fixing the luggage loaded on both the first loading layer and the second loading layer.

The technical concept of the present disclosure has been described in detail with reference to embodiments thereof. However, it should be appreciated by those having ordinary skill in the art that changes may be made in these embodiments without departing from the principles and spirit of the disclosure, the scope of which is defined in the appended claims and their equivalents.

What is claimed is:

1. A luggage loading device for vehicles, the luggage loading device comprising a main body unit configured such that a loading area is capable of being divided into a plurality of sub-loading areas each configured to load luggage therein, wherein the main body unit is configured to selectively slide along a movement path in a vehicle, and wherein the loading area is formed by guide frames provided in forward and rearward directions and side walls provided in leftward and rightward directions.

2. The luggage loading device of claim 1, further comprising an auxiliary body unit configured to be positioned in a withdrawn state in a direction of covering the loading area and configured to form an auxiliary loading area having a multistage structure with the loading area so that luggage can be loaded in the auxiliary loading area in the withdrawn state of the auxiliary body unit.

3. The luggage loading device of claim 1, wherein the main body unit comprises:
a main body configured such that the loading area is formed therein; and
guide rails mounted on a lower part of the main body and coupled to sliding rails fixed to a vehicle body so as to allow the main body to slide.

4. The luggage loading device of claim 3, wherein each of the guide rails comprises a sliding guide mounted therein so as to come into direct contact with a corresponding one of the sliding rails and formed of mono-cast (MC) nylon.

5. The luggage loading device of claim 3, wherein the main body unit further comprises:
a front latch configured to engage a striker that protrudes on the movement path so as to fix a position of the main body, as the main body slides from an initial position thereof to a withdrawn position; and
a rear latch disposed to be spaced apart from the front latch and configured to engage the striker so as to fix the position of the main body, as the main body slides from the withdrawn position to the initial position.

6. The luggage loading device of claim 5, wherein the main body unit further comprises a control panel coupled to the main body and configured to control the main body so as to selectively disengage the front latch or the rear latch from the striker.

7. The luggage loading device of claim 6, wherein the control panel comprises:
a button member provided to be exposed;
rotating links configured to be rotated as the button member is pressed; and
operating wires configured to be connected to the rotating links and to extend towards the front latch and the rear latch and to be pulled due to rotation of the rotating links so as to selectively disengage the front latch or the rear latch from the striker.

8. The luggage loading device of claim 3, wherein the main body unit further comprises partition members configured to divide the loading area into the plurality of sub-loading areas.

9. The luggage loading device of claim 8, wherein one side of each of the partition members is inserted into a corresponding one of insert grooves provided in a second side wall among the side walls and wherein a remaining side of each of the partition members is inserted into a corresponding one of receipt grooves provided on a first side wall among the side walls configured to face the second side wall when the partition members are mounted in the loading area.

10. The luggage loading device of claim 9, wherein:
the insert grooves are formed in a T shape corresponding to a shape of one side of each of the partition members and are provided in the second side wall so as to be spaced apart from each other at equal intervals; and
the receipt grooves are formed by a pair of protruding pieces configured to receive the remaining side of each of the partition members and are provided on the first side wall so as to be spaced apart from each other at intervals equal to the intervals between the insert grooves.

11. The luggage loading device of claim 9, wherein:
each of the partition members has a protrusion configured to be inserted into a corresponding one of guide slots provided in a bottom surface of the main body when mounted in the loading area; and
the guide slots align with corresponding ones of the insert grooves and the receipt grooves.

12. The luggage loading device of claim 8, wherein the partition members are provided so that heights thereof are adjustable and are provided at the same height or at different heights.

13. The luggage loading device of claim 12, wherein the partition members are provided to be slidable along the side walls so as to divide the loading area into the plurality of sub-loading areas having the same size or different sizes.

14. The luggage loading device of claim 13, wherein each of the partition members has a stopper engaged with a guide member configured to extend in a length direction of the side walls so as to be selectively slidable depending on disengagement of the stopper from the guide member.

15. The luggage loading device of claim 3, wherein the main body unit is configured such that the side walls comprise a first side wall and a second side wall, and wherein the first side wall disposed towards an entrance in the vehicle is partially openable.

16. The luggage loading device of claim 15, wherein the first side wall comprises:
a handle formed to be gripped by a user's hand;
a first gear engaged with a guide gear formed on the handle so as to be rotatable together with the guide gear as the handle is moved in an operating direction; and
second gears engaged with upper and lower parts of the first gear, disposed to overlap each other so as to be fixed to the guide frame and a fixed region of the first side wall, and configured such that fixation of the second gears to the guide frame and the fixed region of the first side wall is released due to rotation of the first gear.

17. A luggage loading device for vehicles, the luggage loading device comprising:
at least one main body unit configured such that a loading area is capable of being divided into a plurality of sub-loading areas configured to load luggage therein, wherein the main body unit is configured to selectively slide along a movement path in a vehicle and wherein the loading area is formed by guide frames provided in forward and rearward directions and side walls provided in leftward and rightward directions; and
at least one auxiliary body unit configured to be positioned in a withdrawn state in a direction of covering the loading area and configured to form an auxiliary loading area having a multistage structure with the loading area so that luggage can be loaded in the auxiliary loading area when the at least one auxiliary body unit is in the withdrawn state.

18. The luggage loading device of claim 17, wherein the at least one main body unit is configured such that at least one of the side walls provided in the leftward and rightward directions is selectively openable.

19. The luggage loading device of claim 17, wherein the at least one main body unit comprises a plurality of main body units configured such that movement directions thereof in the vehicle are equal or different.

20. The luggage loading device of claim 17, wherein the at least one auxiliary body unit is mounted on at least one of a side wall of a partition of the vehicle, the partition configured to divide a driver's seat from other areas, or on a rear surface of a seat in the vehicle so as to form the auxiliary loading area.
